(19) United States
(12) Patent Application Publication
(10) Pub. No.: US 2021/0096349 A1
(43) Pub. Date: Apr. 1, 2021

(54) IMAGING DEVICE AND METHOD FOR IMAGING AN OBJECT USING A MICROSCOPE

(71) Applicant: LEICA MICROSYSTEMS CMS GMBH, Wetzlar (DE)

(72) Inventors: Benjamin DEISSLER, Butzbach (DE); Christian SCHUMANN, Lich (DE)

(21) Appl. No.: 17/024,739

(22) Filed: Sep. 18, 2020

(30) Foreign Application Priority Data
Sep. 27, 2019 (EP) 19200116.2

(51) Int. Cl. G02B 21/36; G02B 21/06; H04N 5/225; G01N 21/41

(52) U.S. Cl. CPC G02B 21/361; G02B 21/06; G01N 2021/4173; H04N 5/2256; G01N 21/41; H04N 5/2258

(57) ABSTRACT

An imaging device for a microscope includes an optical imaging system configured to form at least two optical images of an object in at least two different focusing states, and a processor configured to process image information from the at least two optical images in order to obtain phase information that is characteristic of the object being imaged. The optical imaging system comprises an image sensor module having at least two image sensors each being associated with a respective one of the at least two different focusing states. The at least two image sensors are configured to simultaneously detect the at least two optical images for generating the image information. The image sensor module comprises an adjustable aperture element which is controllable by the processor.

### CROSS-REFERENCE TO PRIOR APPLICATION

Priority is claimed to European Patent Application No. EP 19200116.2, filed on Sep. 27, 2019, the entire disclosure of which is hereby incorporated by reference herein.

### FIELD

The present invention relates to an imaging device for a microscope, comprising an optical imaging system configured to form at least two optical images of an object in at least two different focusing states, and a processor configured to process image information from said at least two optical images to obtain phase information, said phase information being characteristic of said object being imaged. Further, the present invention relates to a method for imaging an object using a microscope.

### BACKGROUND

Phase-contrast microscopy is an imaging method in light microscopy using the fact that, in addition to the amplitude, the phase of light changes in accordance with a refractive index of a medium through which light is transmitted. This allows directly imaging object structures having only low inherent contrast. Otherwise, those object structures would be visible in a bright-field microscopy only with artificial coloration. Accordingly, phase-contrast microscopy is widely used for examination of transparent biological objects in which different object parts vary only slightly in light absorption but significantly in refractive index.

Commonly applied methods are the phase-contrast method according to Zernike and the differential interference contrast (DIC) method according to Nomarski. However, these methods are not applicable for imaging e.g. phase objects located in so-called microtiter plates or well plates. One reason for this is that these microtiter plates are generally made of plastic which is birefringent and thus influences the polarization of the light, the polarization being utilized in DIC. Further, in microtiter plates with small diameters, e.g. so-called “96-well plates”, a meniscus forms in a liquid (e.g. cell culture medium) on a surface thereof to air. Such a meniscus shifts the image of a light ring like a lens surface. This shifts the image of a ring shaped aperture included in a condenser lens relative to a phase ring included in an objective lens when applying the phase-contrast method according to Zernike, and therefore decreases the contrast achieved by this method.

Furthermore, in many evaluation methods e.g. confluence measurement, etc., it is necessary to apply a segmentation of the recorded image. However, it is much more difficult to perform such a segmentation of a recorded image based on phase-contrast, DIC, or modulation-contrast methods compared to e.g. fluorescence imaging. This is partly due to non-linear contrast mechanisms inherent in these contrast methods. Thus, a bright spot in the recorded image does not necessarily mean that a corresponding object site has a large thickness or a large refractive index. Accordingly, a coloration-free contrast method would be beneficial enabling an object property, e.g. a phase shift, to be measured in a linear manner, whereupon a segmentation can be performed.

There exist different approaches to perform a so-called quantitative phase imaging (QPI) in which the phase shift is measured, i.e. the difference of optical path length when the light passes through the object. A possible approach is disclosed in Mir et al., “Quantitative Phase Imaging”, Progress in Optics, Volume 57, 133 (2012). Such approaches may simplify segmentation considerably, as areas with greater thickness or greater refractive index can be easily distinguished from the background. However, many approaches are based on interference and are therefore disturbable and costly to implement. In particular, approaches based on interference require coherent illumination, for example laser light, and the specific components for separating and combining multiple beam paths. Integrating those components into common microscope systems is difficult, and regulatory requirements due to laser safety must also be observed.

Thus, it is desirable to determine the phase shift without relying on interference. There are two methods which allow the phase distribution of an object to be calculated quantitatively from a plurality of images without using interference.

Firstly, in a differential phase-contrast (DPC) method two images are captured based on an asymmetrical illumination, and the phase distribution is reconstructed from these images. Such a DPC method is disclosed in Tian and Waller, “Quantitative differential phase contrast imaging in an LED array microscope”, Optics Express, Volume 23, 11394 (2015). Secondly, in a defocus contrast method two images are captured with a defocus of the same amount but opposite directions. The phase distribution is reconstructed from the defocused images. A defocus contrast method is disclosed in Kou et al., “Quantitative phase restoration by direct inversion using the optical transfer function”, Optics Letters Volume 36, 2671 (2011).

The differential phase-contrast method and the defocus contrast method apply sequential imaging, i.e. the two images are captured one after the other. Further, both methods are based on the knowledge of the contrast transfer function, especially the phase transfer function of the optical system. The phase transfer function is a function of both the illumination distribution of the illumination system and the pupil transfer function of the imaging system. Accordingly, exact knowledge of the contrast transfer function is necessary to get reliable results from back calculation.

As mentioned above, in case of DPC, asymmetric illumination is used to generate contrast. However, when using microtiter plates, it is difficult to obtain accurate knowledge of the illumination distribution as the presence of the aforementioned meniscus causes unknown distortion and shift of the illumination distribution.

In case of the defocus contrast method, the defocus is usually implemented on the object side by shifting the objective lens relative to the object along the optical axis. Thus, a mechanical movement is utilized for defocusing, requiring motorization and limiting the frame rate as no image can be captured during displacement.

Further, document US 20070182844 A1 discloses a system for producing two different defocused images by means of a beam splitter. However, this system is not flexible in terms of integration into a microscope providing different magnifications.

### SUMMARY

In an embodiment, the present invention provides an imaging device for a microscope. The imaging device includes an optical imaging system configured to form at least two optical images of an object in at least two different focusing states, and a processor configured to process image information from the at least two optical images in order to obtain phase information that is characteristic of the object being imaged. The optical imaging system comprises an image sensor module having at least two image sensors each being associated with a respective one of the at least two different focusing states. The at least two image sensors are configured to simultaneously detect the at least two optical images for generating the image information. The image sensor module comprises an adjustable aperture element which is controllable by the processor.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 is a schematic diagram illustrating a microscope according to an embodiment of the present invention;

FIG. 2 is a schematic diagram of an image sensor module included in the microscope shown in FIG. 1;

FIG. 3 is a schematic diagram of an image sensor module according to a modified embodiment of the present invention;

FIG. 4 is a schematic diagram of an image sensor module according to another modified embodiment of the present invention;

FIG. 5 is a schematic diagram illustrating a microscope according to a modified embodiment of the present invention comprising a plurality of objectives; and

FIGS. 6A to 6C are diagrams illustrating phase transfer functions for an exemplary set of objectives having different magnifications.

### DETAILED DESCRIPTION

In an embodiment, the present invention provides an imaging device for a microscope and a method enabling improved phase-based imaging of samples, in particular when the samples are located in microtiter plates.

An imaging device for a microscope according to an embodiment of the present invention comprises an optical imaging system configured to form at least two optical images of an object in at least two different focusing states, and a processor configured to process image information from said at least two optical images in order to obtain phase information, said phase information being characteristic of said object being imaged. The optical imaging system comprises an image sensor module having at least two image sensors associated with said at least two different focusing states, respectively, said at least two image sensors being configured to simultaneously detect said at least two optical images for generating said image information. The image sensor module comprises an aperture element which is controllable by said processor.

As explained above, conventional defocus contrast methods apply sequential imaging in order to obtain phase information which is characteristic of the object to be imaged. In contrast, by providing an image sensor module with at least two image sensors, the imaging device proposed herein enables the optical images to be detected simultaneously. Accordingly, there is no need to utilize a mechanical movement for an object-side defocusing as provided in conventional methods. As a result, the frame rate is not limited by focusing. Further, it is not necessary to motorize the objective or the microscope stage rendering the system less complex and reducing costs.

The image sensors may be formed by cameras, e.g. CCD or CMOS cameras, which are positioned within the image sensor module such that the lengths of the optical paths along which detection light propagates to the cameras differ from each other.

In contrast to conventional approaches like DPC, the imaging device advantageously avoids asymmetrical illumination. Accordingly, the imaging device is less sensitive to detrimental effects caused by a liquid meniscus typically occurring in a microtiter plate. As a result, reconstructing the phase information from the defocused images becomes easier.

Further, the imaging device is not subject to any restrictions regarding a possible segmentation of the recorded image. In particular, the solution proposed herein enables phase information to be obtained without using artificial object colorization.

The image sensor module comprises an aperture element which can be controlled by the processor in order to vary an effective numerical aperture of an objective which is included in the optical imaging system. In particular, the aperture element can be used to adapt the effective numerical aperture of the objective to the magnification thereof. Thus, it is possible to maintain a ratio of the effective numerical aperture to the magnification at a constant value even in case that the magnification varies. For example, the magnification may change when a set of objectives having different magnifications is provided, each of these objectives being selectively insertable into the optical path of the microscope, e.g. by means of an objective changer.

Preferably, the at least two image sensors are located offset to each other along an optical axis direction of the optical imaging system for providing two different optical path lengths associated with said at least two optical images, respectively.

In particular, the at least two image sensors may be arranged on different image planes along the optical axis direction, said image planes being located on opposite sides of a focus plane of said optical imaging system at predetermined distances therefrom. The aforementioned focus plane is to be understood as defining a nominal optical path length associated with an optimally focused image. Correspondingly, the aforementioned image planes are to be understood as defining optical path lengths which differ from each other as well as from said nominal optical path length. Accordingly, it is evident that the optical axis direction is not to be understood as being limited to one single light propagation direction. Rather, the optical axis direction may comprise a plurality of light propagation directions e.g. created by a beam splitter being configured to split a single optical path into several optical paths.

Preferably, the aforementioned predetermined distances of the image planes from the focus plane are chosen such that the object-side defocus is approximately equal to the depth of field of the optical imaging system.

According to a preferred embodiment, the image sensor module comprises a beam splitter configured to split light from the object into at least two light beams associated with the at least two image sensors, respectively. By using a beam splitter, the different optical path lengths associated with the two image sensors can be implemented easily.

The processor may be included in the image sensor module. Using a module integrated processor enables the phase distribution to be reconstructed from the images in the sensor module itself. Thus, necessary calculations can be performed very fast. Further, bandwidth required for image data transfer can be saved as only one calculated image has to be transferred rather than two raw images

In a preferred embodiment, an interface may be provided for integrating the image sensor module into the optical imaging system by coupling the image sensor module to the interface device. Thus, existing microscope systems can easily be supplemented with the image sensor module in order to obtain phase information as described above.

The optical imaging system may comprise at least one objective configured to collect light from the object. The objective may be a lens exclusively used for imaging the object. Alternatively, the objective may be configured to additionally illuminate the object.

In a specific embodiment, the optical imaging system comprises a plurality of objectives having different magnifications, being selectively positionable on an optical axis of the optical imaging system to collect light from the object. In order to selectively position one of the objectives on the optical axis, the imaging device may comprise a suitable objective changer.

Preferably, the processor is configured to control the aperture element to adapt the effective numerical aperture of the objective to a magnification of the optical imaging system such that a ratio of the effective numerical aperture to the magnification equals a predetermined value.

As already mentioned above, preferably, the object-side defocus is approximately equal to the depth of field (≈λ/NA²) of the optical imaging system, λ designating the wavelength and NA designating the numerical aperture of the objective. Further, the image-side defocus is given by M² times the object-side defocus, M being the magnification of the optical imaging system. Thus, a ratio M/NAᵢₘ should be approximately constant in case a plurality of objectives with different magnifications are used (NAᵢₘ being the effective numerical aperture of the objective, i.e. the imaging aperture). As a result, the aforementioned embodiment is especially advantageous when using a plurality of objectives having different magnifications.

The aperture element, which is included in the image sensor module and preferably adjustable e.g. by a motor, can be used to limit the effective numerical aperture NAᵢₘ. In particular, the aperture element may be located in or near a plane into which a pupil of the objective is imaged. Adjusting the aperture element allows a constant ratio M/NAᵢₘ to be achieved for a plurality of objectives having different magnifications. For example, when using an objective with magnification 40× and NAᵢₘ=0.64, the aperture can be adjusted so that an objective with magnification 20× is used with NAᵢₘ=0.32, an objective with magnification 10× has NAᵢₘ=0.16, and an objective with magnification 5× has NAᵢₘ=0.08.

Preferably, the optical imaging system comprises an optical illumination device configured to illuminate the object, wherein a numerical aperture of the optical illumination device may be adapted to the numerical aperture of the objective such that a ratio of the numerical aperture of the optical illumination device to the numerical aperture of the objective equals a predetermined value. In case that the ratio NAᵢₗₗ/NAᵢₘ is constant (NAᵢₗₗ designating the numerical aperture of the optical illumination device, i.e. the illumination aperture), the contrast transfer function is identical for all objectives. Accordingly, the contrast transfer function has to be calculated and stored only once.

Preferably, the optical imaging system comprises a tube lens. In this case, the sensor module may comprise an optical adaption system configured to adapt a magnification of the tube lens to the at least two image sensors. By providing an optical adaption system, the optical sensor module may be integrated with the optical imaging system irrespective of the specific magnification of the tube lens.

The adjustable aperture element may be included in the optical adaption system. For example, the optical adaption system may comprise two optical systems provided on opposite sides with respect to a plane into which a pupil of the objective is imaged. In such a configuration, the aperture element may be located in or close to the afore mentioned plane.

Preferably, the optical imaging system is configured to provide a predetermined phase transfer function, and the processor is configured to process image information based on the predetermined phase transfer function for acquiring a phase distribution of the object.

In the first step of a possible process, the two images are normalized and subtracted from each other to give a difference image:

I_{dif}(x)=I_{+Δz}(x)−I_{-Δz}(x),

where I_{+Δz}(x) and I_{-Δz}(x) are normalized images with positive and negative defocus, respectively, and x indicates the spatial coordinates. The difference image for a given phase distribution of the object ϕ(x) and phase transfer function PTF can be written as

[symbol]

{I_{dif}}=PTF· [symbol] {ϕ},

where [symbol] {·} indicates a Fourier transform. The phase distribution can be calculated from a minimization problem:

min∥ [symbol] {I_{dif}}−PTF· [symbol] {ϕ}∥₂+α·R(ϕ),

where R(ϕ) is a renormalization term and α a renormalization parameter. In the particularly simple case of Tikhonov regularization, i.e.

R(ϕ)=∥ [symbol] {ϕ}∥₂,

the minimization can be done analytically, leading to

$$ℱ \{ φ \} = \frac{{PTF}^{*}}{{\vert PTF \vert}^{2} + α} ℱ \{ {I}_{dif} \} .$$

Further, the processor may be configured to take into account a spherical aberration when processing image information based on the predetermined phase transfer function.

The reasoning, according to which the object side defocus and image side defocus are described equally (differing only by a factor M²), applies only in paraxial approximation. Specifically, a residual wavefront error remains given by

$$Δ {z}_{1} \sqrt{{n}_{1}^{2} - {NA}^{2} {ρ}^{2}} - Δ {z}_{2} \sqrt{{n}_{2}^{2} - \frac{{NA}^{2}}{{M}^{2}} {ρ}^{2}} ,$$

wherein Δz₁, Δz₂ designate the object-side defocus and the image-side defocus, respectively, n₁, n₂ designate the object-side refractive index and the image-side refractive index, respectively, and ρ designates the normalized radius in the pupil. This residual wavefront error can be taken into account when recalculating the phase distribution. A method for recalculating the phase distribution is e.g. described in the document JP 4917404 B2. In this document, however, only the paraxial approximation for the wavefront induced by defocus is applied (see equation (20) of the document). Therefore, the approach described herein is more precise. Thus, on the one hand, the present approach considers high aperture effects. On the other hand, the present approach additionally considers the spherical aberration due to the image-side defocusing as described above.

According to another embodiment of the invention, a method for imaging an object using a microscope is provided, comprising the following steps: forming at least two optical images of the object in at least two different focusing states, and processing image information from the at least two optical images in order to obtain phase information, said phase information being characteristic of the object being imaged. The at least two optical images are simultaneously detected for generating the image information by means of an image sensor module having at least two image sensors associated with the at least two different focusing states, respectively.

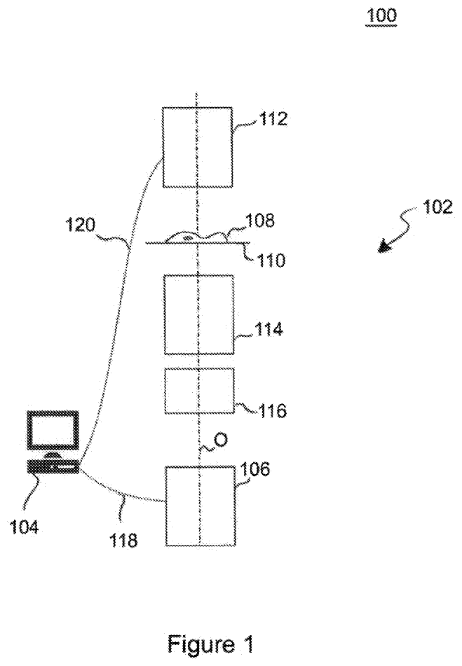

FIG. 1 is a schematic diagram showing an imaging device 100 for a microscope. The imaging device 100 comprises an optical imaging system 102, a processor 104, and an image sensor module 106.

The optical imaging system 102 is configured to form an optical image of an object 108 being located on a stage 110. In addition to the image sensor module 106, the optical imaging system 102 may comprise an optical illumination device 112, at least one objective 114, and a tube lens 116. According to the specific embodiment shown in FIG. 1, the microscope is configured as a transmitted-light microscope of inverted type. Accordingly, the optical illumination device 112 is located above the stage 110, wherein the objective 114 is arranged below the stage 110.

The processor 104 may be formed by an external computer configured to control overall operation of the imaging device 100. Specifically, the processor 104 controls an imaging operation performed by the image sensor module 106. Additionally, the processor 104 may control the optical illumination device 112, in particular a numerical aperture thereof as described below. Correspondingly, the processor 104 is connected to the image sensor module 106 and the optical illumination device 112 via control lines 118 and 120, respectively.

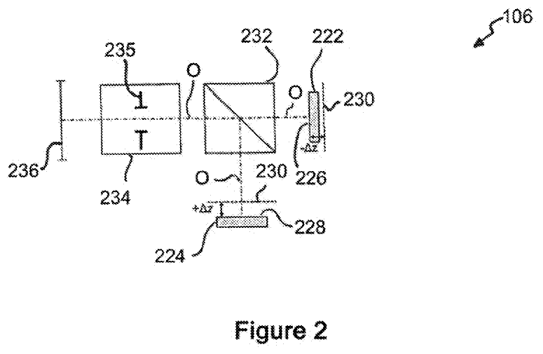

FIG. 2 shows an exemplary configuration of the image sensor module 106. According to this configuration, the image sensor module 106 comprises a first image sensor 222 and a second image sensor 224. The image sensors 222, 224 are located offset to each other in direction of an optical axis O. Specifically, light receiving surfaces 226, 228 of the image sensor 222, 224, respectively, may be located on image planes which are offset relative to a nominal focus plane 230 in direction of the optical axis O. The nominal focus plane 230 defines an image plane on which an optimally focused image of the object would be formed by the optical system 102. In other words, the focus plane 230 defines a nominal optical path associated with an optimally focused image.

In the exemplary configuration of FIG. 2, the light receiving surfaces 226, 228 of the image sensors 222, 224 are distant from the focus plane 230 by equal amounts ±Δz, however located on opposite sides relative to the focus plane 230.

The image sensor module 106 may comprise a beam splitter 232 which splits light entering the image sensor module 106 into a first light beam propagating to the first image sensor 222 and a second light beam propagating to the second image sensor 224. Further, according to the embodiment shown in FIG. 2, the image sensor module 106 comprises an optical adaption system 234 which serves to adapt a magnification of the tube lens 116 to the dimensions of the light receiving surfaces 226, 228 of the image sensors 222, 224.

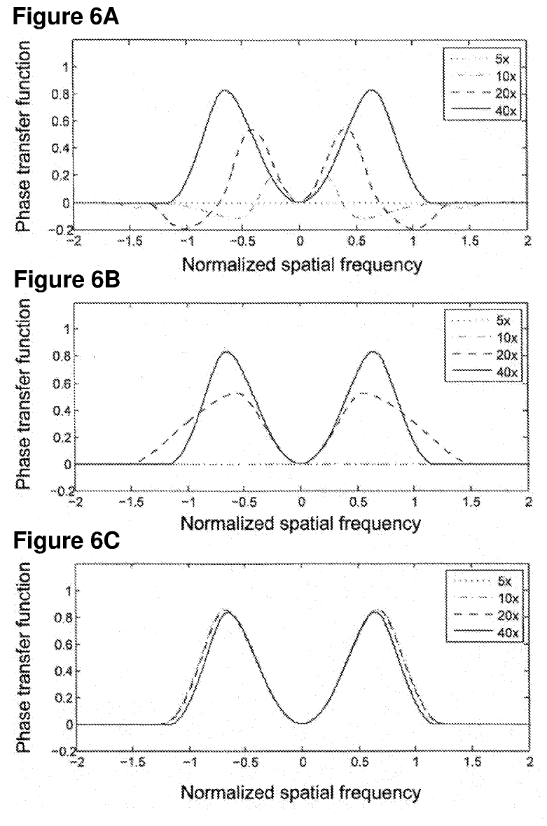

The image sensor module 106 includes an adjustable, preferably motorized aperture element 235 which is controlled by the processor 104 to vary an effective numerical aperture of the objective 114 as needed. Although not limited thereto, an advantageous effect of controlling the effective numerical aperture by means of the adjustable aperture element 235 will be illustrated below with reference to FIGS. 6A to 6C.

As shown in FIG. 2, the imaging device comprises an interface device 236 wherein the image sensor module 106 can be coupled to the interface device 236 in order to integrate the image sensor module 106 into the optical imaging system 102. Thus, according to the embodiment shown in FIG. 2, the image sensor module 106 is detachably provided within the optical imaging system 102. Alternatively, the image sensor module 106 may be permanently installed in the optical imaging system 102.

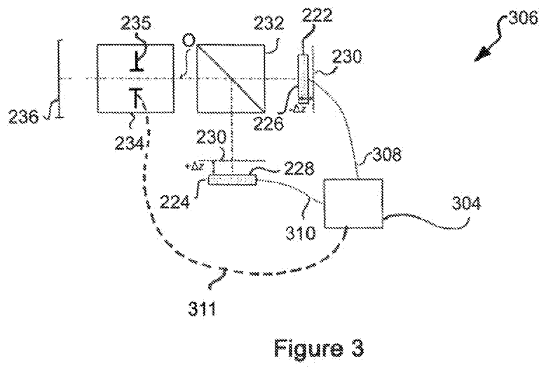

FIG. 3 shows an image sensor module 306 according to a modified embodiment. The image sensor module 306 differs from the configuration shown in FIG. 2 in that the image sensor module 306 includes an integrated processor 304 replacing the external processor 104. The integrated processor 304 is configured to control the image sensors 222, 224 and the aperture element 235 via control lines 308, 310, 311 respectively. By integrating the processor 304 with the image sensor module 306, calculations for obtaining the phase distribution of the object can be performed faster.

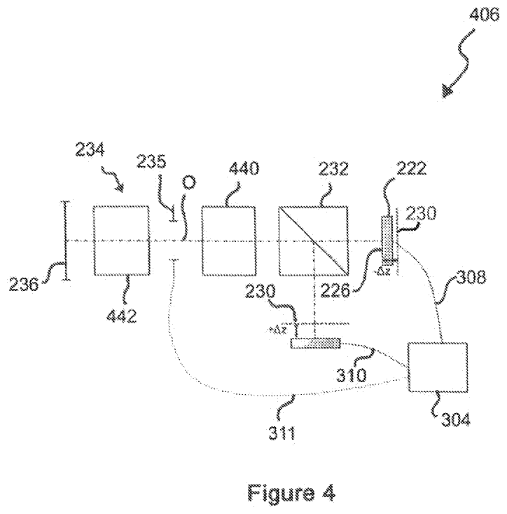

FIG. 4 shows an image sensor module 406 according to a further embodiment which is based on the configurations shown in FIGS. 2 and 3. The image sensor module 406 comprises two optical systems 440, 442 forming the optical adaption system 234. The adjustable aperture element 235 is located between the optical systems 440, 442 in or near a plane into which a pupil of the objective 114 is imaged. The optical system 442 images the pupil of the objective 114 into or near the plane in which the aperture element 235 is located. In combination with the optical system 440, the object is imaged onto the focal plane 230 with a magnification that is adapted to the dimensions of the light receiving surfaces 226 and 228.

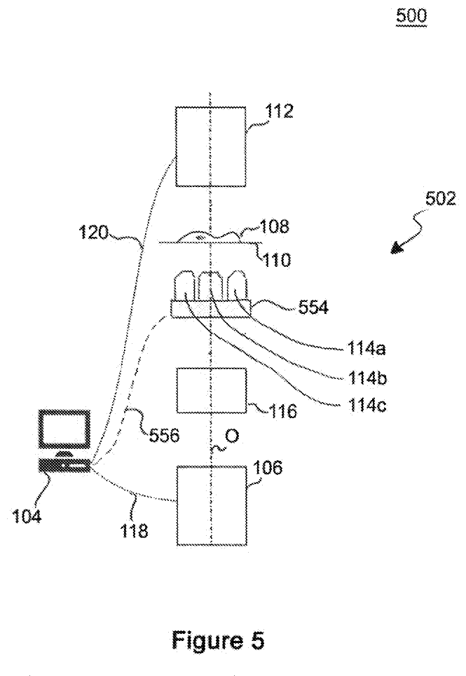

By providing the image sensor module 106 with the adjustable aperture element 235, the image sensor module 106 is particularly suitable to be used in combination with a configuration comprising a set of objectives for changing the total magnification of the microscope. FIG. 5 shows a correspondingly modified imaging device 500. An optical imaging device 502 of the imaging device 500 differs from the embodiment shown in FIG. 1 by an objective changer 554 carrying a plurality of objectives 114a, 114b, 114c having different magnifications. The objective changer 554 is controlled by the processor 104 via a control line 556 in order to selectively position one of the objectives 114a, 114b, 114c on the optical axis O of the optical imaging system 502. By doing so, the processor 104 changes the magnification as needed.

The adjustable aperture element 235 may be used to control the effective numerical aperture of the selected objective 114a, 114b, 114c dependent on the specific magnification thereof. The effect achieved by controlling the effective numerical aperture is illustrated in FIGS. 6A to 6C.

FIGS. 6A to 6C show exemplary phase transfer functions for a set of four objectives characterized by specific values for the ratio M/NAᵢₘ, namely 40×/0.64, 20×/0.45 10×/0.25, and 5×/0.15.

FIG. 6A illustrates a case in which the numerical aperture NAᵢₘ of the respective objective is not adapted; the illumination aperture (i.e. numerical aperture of the optical illumination device 112) NAᵢₗₗ is kept constant at 0.16; and the object-side defocus corresponds to the depth of field of the 40× objective. As can be seen from FIG. 6A, the phase transfer functions are very different. For the 20× and 10× objectives, the peak values of the transfer functions are lower than the peak values for the 40× objective. Further, the transfer functions for the 20× and 10× objectives have zero crossings. These zero crossings are disadvantageous as there is no sensitivity at spatial frequencies corresponding to zero crossings causing artifacts when recalculating the phase distribution. For the 5× objective, the transfer function is always zero since the illumination aperture NAᵢₗₗ is larger than the imaging aperture NAᵢₘ.

FIG. 6B illustrates a case in which the imaging aperture NAᵢₘ is adapted such that the object-side defocus corresponds to the depth of field of the objective used. Again, the illumination aperture NAᵢₗₗ is constant at 0.16. For the 20× objective, the zero has disappeared. However, for the 10× and 5× objectives the transfer function is always zero since the illumination aperture NAᵢₗₗ is larger than the imaging aperture NAᵢₘ.

FIG. 6C illustrates a case in which the illumination aperture is also adjusted such that NAᵢₗₗ=0.5 NAᵢₘ. Here, the phase transfer functions are almost identical.

Various modifications of the embodiments described above are possible. For example, according to the embodiments shown in FIGS. 2 to 4, the aperture element 235 is included in the optical adaption system 234. However, the aperture element 235 may also be located at another position inside the image sensor module 106, 306, 406.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 imaging device
102 optical imaging system
104 processor
106 image sensor module
108 object
110 stage
112 optical illumination device
114, 114a, 114b, 114c objective
116 tube lens
118 control line
120 control line
222 image sensor
224 image sensor
226 light receiving surface
228 light receiving surface
230 focus plane
232 beam splitter
234 optical adaption system
235 aperture element
304 a processor
306 image sensor module
308 control line
310 control line
311 control line
438 control line
440 optical system
442 optical system
500 imaging device
502 optical imaging system
554 objective changer
556 control line

What is claimed is:

1. An imaging device for a microscope, the imaging device comprising:
an optical imaging system configured to form at least two optical images of an object in at least two different focusing states; and
a processor configured to process image information from the at least two optical images in order to obtain phase information that is characteristic of the object being imaged,
wherein the optical imaging system comprises an image sensor module having at least two image sensors each being associated with a respective one of the at least two different focusing states, the at least two image sensors being configured to simultaneously detect the at least two optical images for generating the image information, and
wherein the image sensor module comprises an adjustable aperture element which is controllable by the processor.

2. The imaging device according to claim 1, wherein the at least two image sensors are located offset to each other along an optical axis direction of the optical imaging system so as to provide two different optical path lengths each being associated with a respective one of the at least two optical images.

3. The imaging device according to claim 2, wherein the at least two image sensors are arranged on different image planes along the optical axis direction, the image planes being located on opposite sides of a focus plane of the optical imaging system in predetermined distances therefrom.

4. The imaging device according to claim 3, wherein the predetermined distances of the image planes from the focus plane are chosen such that an object-side defocus is approximately equal to a depth of field of the optical imaging system.

5. The optical imaging device according to claim 1, wherein the image sensor module comprises a beam splitter configured to split light from the object into at least two light beams each being associated with a respective one of the at least two image sensors.

6. The imaging device according to claim 1, wherein the processor is included in the image sensor module.

7. The imaging device according to claim 1, further comprising an interface device configured to integrate the image sensor module into the optical imaging system by coupling the image sensor module to the interface device.

8. The imaging device according to claim 1, wherein the optical imaging system comprises at least one objective configured to collect light from the object.

9. The imaging device according to claim 1, wherein the optical imaging system comprises a plurality of objectives having different magnifications, each of the objectives being selectively positionable on an optical axis of the optical imaging system so as to collect light from the object

10. The imaging device according to claim 8, wherein the processor is configured to control the adjustable aperture element so as to adapt an effective numerical aperture of the objective to a magnification of the optical imaging system such that a ratio of the effective numerical aperture to the magnification equals a predetermined value.

11. The imaging device according to claim 8, wherein the optical imaging system comprises an optical illumination device configured to illuminate the object, and wherein a numerical aperture of the optical illumination device is adaptable to an effective numerical aperture of the objective such that a ratio of the effective numeral aperture of the optical illumination device to the numerical aperture of the objective equals a predetermined value.

12. The imaging device according to claim 1, wherein the optical imaging system comprises a tube lens, and wherein the image sensor module comprises an optical adaption system configured to adapt a magnification of the tube lens to the at least two image sensors.

13. The imaging device according to claim 1, wherein the optical imaging system is configured to provide a predetermined phase transfer function, and wherein the processor is configured to process the image information based on the predetermined phase transfer function for acquiring a phase distribution of the object.

14. The imaging device according to claim 13, wherein the processor is configured to take into account spherical aberration when processing the image information based on the predetermined phase transfer function.

15. A method for imaging an object using a microscope, the method comprising:
forming at least two optical images of the object in at least two different focusing states; and
processing image information from the at least two optical images in order to obtain phase information that is characteristic of the object being imaging,
wherein the at least two optical images are simultaneously detected for generating the image information by an image sensor module having at least two image sensors each being associated with a respective one of the at least two different focusing states.
